(19) United States
(12) Patent Application Publication
(10) Pub. No.: US 2021/0311689 A1
(43) Pub. Date: Oct. 7, 2021

(54) WEARABLE AUDIO DEVICE AND OPERATION METHOD THEREOF

(71) Applicants: Gwang Hyun Kwon, Seoul (KR); BPM Inc., Seoul (KR)

(72) Inventor: Gwang Hyun Kwon, Seoul (KR)

(73) Assignees: BPM Inc., Seoul (KR); Gwang Hyun Kwon, Seoul (KR)

(21) Appl. No.: 16/885,232

(22) Filed: May 27, 2020

(30) Foreign Application Priority Data
Apr. 1, 2020 (KR) 10-2020-0039550

(51) Int. Cl. G06F 3/16; H04R 1/10; G01S 19/42

(52) U.S. Cl. CPC G06F 3/165; G01S 19/42; H04R 1/1041

(57) ABSTRACT

A wearable audio device includes: at least one audio module configured to output a sound; and a fixing member having a band shape and comprising at least one coupling part to which the audio module is inserted or attached, wherein the audio module includes: a biological signal detecting part configured to collect a biological signal from a body of a user; a GPS module configured to generate position information of the audio module; and a sound adjusting part configured to determine music to be played through the audio module or a speed of music based on the biological signal collected from the biological signal detecting part or the position information collected from the GPS module.

### CROSS-REFERENCE TO RELATED APPLICATIONS

This U.S. non-provisional patent application claims priority under 35 U.S.C. § 119 of Korean Patent Application No. 10-2020-0039550, filed on Apr. 1, 2020, the entire contents of which are hereby incorporated by reference.

### BACKGROUND

The present invention relates to a wearable audio device and an operation method thereof, and more particularly, to an audio device capable of selecting music to assist an exercise and other activities to be effective by analyzing a body condition and an exercise state of a user, and an operation method thereof.

Various kinds of product lines are provided in an audio device market. The product lines may have various kinds including high cost broadcasting equipment, performance equipment, and speakers such as a car audio and a domestic computer speaker. A product having a highest accessibility to a majority of general consumers among the above-described product lines is a personal audio device that is worn on and used by one person, e.g., an earphone or a headphone.

In recent years, various types of audio devices adopting a wireless communication technology such as Bluetooth have been produced and sold in the personal audio device market. Earphones may include a basic earphone, an earphone having a headphone shape and adopting a wireless technology, and an earphone having a neck band shape. However, a user may feel inconvenience generated when the user wears an earphone or a headphone while exercising. Although the inconvenience is remarkably reduced in comparison with a case of an earphone and a headphone including an electrical line, the user may still feel inconvenience when wears an earphone during exercising because the earphone is escaped out of an ear instead of being fixed at an exact position. Also, the user may steel feel inconvenience when wears a large size headphone because the headphone interrupts a movement during exercising and does not smoothly discharge a body heat and sweat generated around a head during the exercising.

Users wear audio devices during exercising because an exercise effect may increase according to the kind of listening music, and motivation of an exercise may also increase. For example, when the user exercises while listening fast-tempo music, an energy consuming efficiency (oxygen) may increase, and a synchronization phenomenon may be caused by a rhythm and tempo of the music. Also, the user may not feel tedium when the same movement is repeated by listening music.

As the user listens relatively slow-tempo music when performing a cool-down exercise or taking a break after an exercise, a decomposition rate of lactic acid, which is a fatigue material causing a severe injury when accumulated in a body, may increase.

However, the user may still feel inconvenience in manipulation of the audio device because the user has to manipulate a wearing audio device or an electronic device connected to the audio device and arbitrarily manipulate music appropriate to an exercise condition.

The above-described condition requires development of a novel audio device capable of automatically adjusting and providing the kind and speed of music appropriately to the exercise condition of the user and being easily worn during exercising.

### SUMMARY

The present invention provides a music selection function of automatically selecting music appropriately to a body condition of a user and automatically adjusting a speed of music.

The present invention also provides a method for improving an exercise effect customized for individual user through a music setting.

The objects of the present invention are not limited to the aforementioned object, but other objects not described herein will be clearly understood by those skilled in the art from descriptions below.

An embodiment of the present invention provides a wearable audio device including: at least one audio module configured to output a sound; and a fixing member having a band shape and including at least one coupling part to which the audio module is inserted or attached. Here, the audio module includes: a biological signal detecting part configured to collect a biological signal from a body of a user; a GPS module configured to generate position information of the audio module; and a sound adjusting part configured to determine music to be played through the audio module or a speed of music based on the biological signal collected from the biological signal detecting part or the position information collected from the GPS module.

In an embodiment, two audio modules may be provided, one of the audio modules may be inserted or attached to a first coupling part of the fixing member, and the other of the audio modules may be inserted or attached to a second coupling part spaced apart from the first coupling part in the fixing member having a band shape.

In an embodiment, when music to be played through the audio module or a speed of music is determined based on the biological signal collected from the biological signal detecting part or the position information collected from the GPS module, the sound adjusting part may determine the music to be played or the speed of the music by receiving, from a user terminal, information of the music or the speed of the music that is determined by the user terminal configured to receive the biological signal collected from the biological signal detecting part or the position information collected from the GPS module from the wearable audio device.

In an embodiment, the biological signal may be a heart beat rate of the user, and the sound adjusting part may control the music determined based on a user exercise state that is determined based on the heart beat rate of the user and the position information generated through the GPS module to be played by the audio module.

In an embodiment, the biological signal may be a heart beat rate of the user, and, and the sound adjusting part may adjust the speed of the music being played by the audio module based on a user exercise state that is determined based on a heart beat rate of the user and the position information generated through the GPS module.

In an embodiment, the sound adjusting part may measure an exercise effect according to the music played in the audio module and the speed of the music based on the biological signal collected from the biological signal detecting part, and generate a setting value specified for a specific user based on the measured exercise effect.

In an embodiment, the sound adjusting part may determine a timing for changing music based on a current play state of music being played through the audio module after the music to be played through the audio module is determined.

In an embodiment, the sound adjusting part may determine the music to be played or the speed of the music to be played based on situational music preferences or situational music speed preferences of the user.

In an embodiment, the sound adjusting part may additionally adjust a volume of the music to be played or a balance for each frequency band of the music to be played in addition to the music to be played through the audio module or the speed of the music to be played.

In an embodiment of the inventive concept, a method for controlling an audio module by a wearable audio device including at least one audio module includes: collecting a biological signal from a body of a user through a biological signal detecting part contained in the audio module; collecting position information of the audio module through a GPS module contained in the audio module; and determining music to be played through the audio module or a speed of music to be played based on a biological signal collected from the biological signal detecting part or position information collected from the GPS module.

According to the embodiment of the present invention, as the music selection (selection of music and adjustment of the speed of music) is performed by collecting and analyzing the body information, the position information, the exercise situation, and other information of the active user, the exercise effect of the user may increase, and the convenience of the user may improve to ultimately cause the effect of promotion of exercise motivation and health promotion.

According to the embodiment of the present invention, the exercise effect for each user may be maximized by measuring the exercise effect of the user according to various kinds of music and generating and using the setting value customized for each user.

The object of the present invention is not limited to the aforesaid, but other objects not described herein will be clearly understood by those skilled in the art from descriptions below.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating an appearance of a wearable audio device and an operation environment according to an embodiment of the present invention;

FIG. 2 is a schematic block diagram illustrating a configuration of an audio module according to an embodiment of the present invention;

FIG. 3 is a flowchart representing a process of operating the wearable audio device worn on a body of a user according to an embodiment of the present invention;

FIG. 4 is an exemplary view for explaining a wearing shape and an operation method of the wearable audio device according to an embodiment of the present invention;

FIG. 5 is a view illustrating a portion of a detailed structure of the audio module according to an embodiment of the present invention;

FIG. 6 is a view for explaining a portion that is controllable by the user and a vibration generating portion in the detailed structure of the audio module according to an embodiment of the present invention; and

FIG. 7 is a view for explaining a method for attaching and detaching the audio module and a fixing member through a coupling part according to an embodiment of the present invention.

### DETAILED DESCRIPTION

In the following description, the technical terms are used only for explaining a specific exemplary embodiment while not limiting the present disclosure. The terms of a singular form may include plural forms unless referred to the contrary. The meaning of comprises' and/or ‘comprising’ does not exclude other components besides a mentioned component. Like reference numerals denote like elements throughout, and the word ‘and/or’ means that one or more or a combination of relevant constituent elements is possible. It will be understood that although the terms of first and second are used herein to describe various elements, these elements should not be limited by these terms. These terms are only used to distinguish one component from another component. Accordingly, a first component that will be described below may be a second component within the technical idea of the present disclosure.

Furthermore, when it is described that one comprises (or includes or has) some elements, it should be understood that it may comprise (or include or has) only those elements, or it may comprise (or include or have) other elements as well as those elements if there is no specific limitation. Also, terms used in the specification such as “part” or “module” represent a unit performing at least one function or operation, and this may be realized by a hardware, a software, or a combination thereof.

Hereinafter, exemplary embodiments of the present invention will now be described in detail with reference to the accompanying drawings.

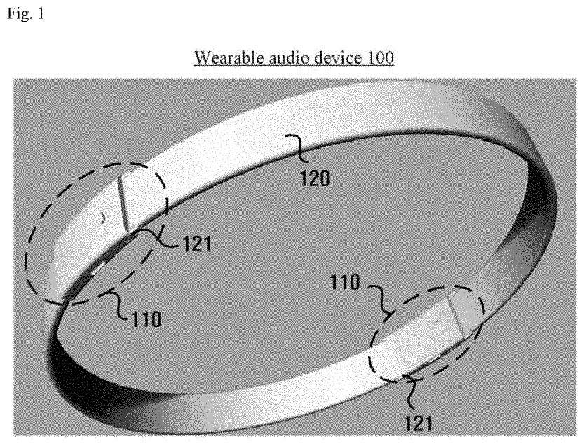

FIG. 1 is a view illustrating an appearance of a wearable audio device 100 and an operation environment according to an embodiment of the present invention.

Referring to FIG. 1, the wearable audio device 100 may include at least one audio module 110 and a fixing member 120.

The audio module 110 may output a sound. In addition, the audio module 110 may collect a biological signal including at least heart rate information from a body of a user and additionally collect other exercise information to determine a music played therein or a speed of music.

The fixing member 120 may have a band shape and be made of various materials such as fabric, silicon, span, and nylon. Here, the various materials may be mixed with a predetermined ratio.

The fixing member 120 may have elasticity. The fixing member 120 may include at least one coupling part 121 to which the audio module 110 is inserted or attached.

As described above, the audio module 110 may be may have a shape capable of being attached to and detached from the coupling part 121. Thus, a user of the wearable audio device 100 may separately clean only the fixing member from which the audio module 110 is detached. The coupling part 121 will be described in detail later with reference to an additional drawing.

The user of the wearable audio device 100 may wear the wearable audio device 100 on one's head like a hairband. Accordingly, the wearable audio device 100 may prevent sweat formed on one's forehead from moving toward eyes by absorbing or drying the sweat, and thus the user may conveniently wear even during exercising. As the user wear the wearable audio device 100 so that the audio module 110 to which the coupling part 121 is inserted or attached is disposed around ears of the user, the user may effectively listen a music played in the audio module 110.

According to an embodiment of the present invention, two audio modules contained in the wearable audio device 100 are provided for left and right sides, respectively. When the user wears the wearable audio device 100 like a hairband, the two audio modules 110 may be disposed in correspondence to a left ear and a right ear of the user, respectively.

The coupling parts 121 disposed on the fixing member 120 may be formed at positions corresponding to left and right ears of the user when the wearable audio device 100 is worn, so that the two audio modules 110 correspond to the left ear and the right ear of the user, respectively. That is, when two audio modules 110 and two coupling parts 121 corresponding thereto are provided, one of the audio modules 110 may be inserted or attached to the first coupling part 121 of the fixing member 120, and the other of the audio modules 110 may be inserted or attached to the second coupling part 121, which is spaced apart from the first coupling part 121, in the fixing member 121 having a band shape.

According to an embodiment, the second coupling part 121 may be disposed at an opposite side of the first coupling part 121 in the fixing member 120 having the band shape.

Referring to FIG. 1, the wearable audio device 100 may operate by communicating with a separate user terminal 200. The audio module 110 may communicate with the user terminal 200 through a wired or wireless communication method. When a plurality of audio modules 110 are contained in the wearable audio device 100, the audio modules 110 may communicate with each other.

The wearable audio device 100 may receive music data to be played from the user terminal 200 and receive all sorts of play related information from the user terminal 200 to operate based on the received information.

The user terminal may include all kinds of handheld-based wireless communication devices capable of being connected to a web server through a network, e.g., a mobile phone, a smartphone, a personal digital assistant (PDA), a portable multimedia player (PMP), and a tablet PC. The user terminal 200 may be one of digital devices having a calculation capacity by including a memory unit and mounting a microprocessor thereto, e.g., a personal computer (a desktop computer, a notebook computer, etc.), a workstation, PDA, and a web pad.

According to an embodiment of the present invention, the user may control all sorts of operations of the wearable audio device 100 through the user terminal 200, and the above-described control may be performed through an application installed in the user terminal 200. The application installed in the user terminal 200 may be updated by receiving all sorts of setting values for operation of the application from an external server (not shown) by performing communication between the user terminal 200 and the external server.

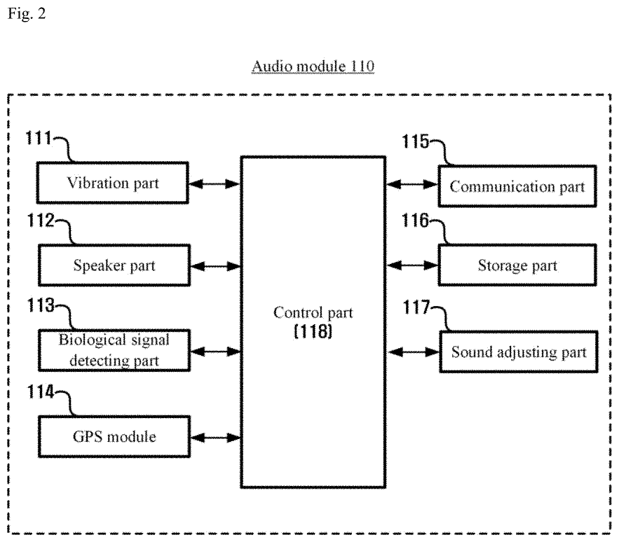

FIG. 2 is a schematic block diagram illustrating a configuration of the audio module 110 according to an embodiment of the present invention.

Referring to FIG. 2, the audio module 110 may include a vibration part 111, a speaker part 112, a biological signal detecting part 113, a GPS module 114, a communication part 115, a storage part 116, a sound adjusting part 117, and a control part 118.

According to an embodiment of the present invention, when the plurality of audio modules 110 are contained in the wearable audio device 100, one main audio module 110 may be present to include all of the above-described components, and other audio modules 110 except for the main audio module 110 may include only components essential for receiving and playing music data, e.g., the vibration part 111, the speaker part 112, and the communication part 115.

The vibration part 111 may output a vibration corresponding to music data, and the speaker part 112 may output a sound corresponding to audio data. According to an embodiment, the speaker part 112 may be provided in plurality, and each of the speaker parts 112 may output a sound in an allocated frequency range.

The biological signal detecting part 113 may collect all sorts of biological signals of the user in the audio module 110 disposed at a peripheral portion of ears of a head of the user when the user wears the wearable audio device 100. The biological signal detecting part 113 may collect various information such as a body temperature, a pulse, an electrocardiogram, a humidity, and a skin pattern of the user.

In a method of measuring the pulse of the user by using the biological signal detecting part 113 according to an embodiment of the present invention, the biological signal detecting part 113 may include a heart rate meter having a type in which an electrical method and an infrared method are separately or mixedly applied. Here, the heart beat meter may adopt and user an I2C communication method.

A GPS module 114 may calculate a current position by using a global positioning system (GPS) technology to generate position information. The GPS module 114 may calculate a distance to each of GPS satellites by using a difference between time information contained in a signal received from a plurality of GPS satellites and a reception time of a signal from each of the GPS satellites, and calculate a current position by using the distance value to the plurality of GPS.

The communication part 115 may allow the audio module 110 to communicate with the user terminal 200, the external server, or other audio modules 110. The communication part 115 may user a network to perform communication, and the network may include various types such as wired and wireless network types, e.g., a local area network (LAN), a metropolitan area network (MAN), a wide area network (WAN), and Bluetooth.

The audio module 110 may receive data of music to be played, selected information of the music to be played, speed information, etc. from the user terminal 200, etc. through the communication part 115, and also receive user setting values that are selected by the user.

The storage part 116 may store information that is collected, generated, and operated in all sorts of components of the audio module 110. For example, the storage part 116 may store all sorts of setting values necessary for an operation of the wearable audio device 100. Also, the storage part 116 itself may store music data to play music through the audio module 110 even when communication between the audio module 110 and the user terminal 200 is not allowed. The above-described storage part 116 may include, e.g., a memory, a cash, and a buffer and consist of a software, a firmware, a hardware, or a combination of at least two thereof.

The sound adjusting part 117 may determine music to be played through the audio module 110 or a speed of music based on a biological signal and position information collected from the biological signal detecting part 113 and the GPS module 114.

According to an embodiment of the present invention, the sound adjusting part 117 may determine a numeric value of a beats per minute (BPM) that is a speed of music according to a heart beat rate of the user, which is one of biological signals. The sound adjusting part 117 may adjust the speed of music, which is currently playing through the audio module 110, appropriately to the determined numeric value of the BPM. Alternatively, the sound adjusting part 117 may change the music, which is currently playing through the audio module 110, into music having the determined numeric value of the BPM.

When the music to be played through the audio module 110 or the speed of the music is determined based on the biological signal or the position information collected from the biological signal detecting part 113 or the GPS module 114, the sound adjusting part 117 may determine the music to be played or the speed of the music according to a user exercise state determined based on the heart beat rate of the user or the heart beat rate and the position information.

According to an embodiment, a movement speed of the user may be calculated based on the position information of the user. Specifically, the movement speed of the user may be calculated through position information that is real-time generated by the GPS module 114.

According to an embodiment, the user exercise state determined by the sound adjusting part 117 may include walking, jogging, and cycling. When the user maintains a BPM state within a predetermined range and a speed in a predetermined range based on combined information of the heart beat rate and the movement speed of the user, the sound adjusting part 117 may determine that the user is performing one of walking, jogging, and cycling. For example, the sound adjusting part 117 may determine that the user is jogging when the user has the heart beat rate of 80 to 140 and the movement speed of 6 to 12 km/h. For another example, the sound adjusting part 117 may determine that the user is moving by a transportation unit instead of exercising when the corresponding user has the heart beat rate of 60 to 70 and the movement speed of 20 km/h that corresponds to that of cycling.

Alternatively, the sound adjusting part 117 may determine which exercise the user is doing (e.g., soccer, basketball, baseball, etc.) based on a situation in which the user performs an exercise having a certain intensity in a space having a certain range by using the BPM information and the position information of the user.

Also, the sound adjusting part 117 may determine kinds of exercises according to the position information of the user. For example, when the user is positioned at a basketball court or therearound, a probability of determining that the user is playing basketball may increase.

According to an embodiment, in a process of determining music to be played by the audio module 110 based on a body state or an exercise state of the user, the sound adjusting part 117 may consider a music genre. For example, although music is played with the same or similar BPM, music in a specific genre may be selected and played among detailed genres such as hip-hop, rock, ballad, jazz, R&B, electronic music, and teuroteu. This selection may be performed based on user's preferences or an exercise effect analysis result.

According to an embodiment of the present invention, in a process of determining music to be played by the audio module 110 based on the biological signal or the position information collected from the biological signal detecting part 113 or the GPS module 114, the sound adjusting part 117 may receive information including music or the speed of music determined from the user terminal 200 and control music played in the audio module 110 through the received information.

That is, in the above-described case, the user terminal 200 may receive the biological signal information or the position information from the audio module 110 of the wearable audio device 100, determine the music to be played through the audio module 110 or the speed of the music by analyzing the received information, and transmit determined information and music data to the audio module 110.

Alternatively, the sound adjusting part 117 itself may determine the music to be played through the audio module 110 or the speed of the music by analysis based on the biological signal information and the position information regardless of the user terminal 200, and control the audio module 110 according to the determined feature. As described above, according to various embodiments of the present invention, the wearable audio device 100 may be used in conjunction with the separate user terminal 200 or used singly without conjunction with the user terminal 200.

The sound adjusting part 117 according to an embodiment of the present invention may measure an exercise effect according to the BPM of music being played or music playing in the audio module 110 based on the biological signal collected from the biological signal detecting part 113, and generate setting values specified to the user based on the measured exercise effect.

For example, the sound adjusting part 117 may analyze an improvement ratio of the exercise effect when a specific user listens specific music in comparison with other music. Similarly, the sound adjusting part 117 may analyze an improvement ratio of the exercise effect when a specific user listens music having a specific BPM in comparison with music having a different BPM. This analysis may be customized individually to the heart beat rate or the exercise state (the kind of exercise) of the user.

According to an embodiment, measurement of the exercise effect by the sound adjusting part 117 may be performed by calculating calories consumed per a predetermined time.

As described above, the sound adjusting part 117 may generate setting values specified to a specific user based on the exercise effect measured according to each condition, and select music or a speed of music capable of maximizing the exercise effect of the user by using the generated setting values.

According to an embodiment of the present invention, after music to be played through the audio module 110 is determined, the sound adjusting part 117 may determine a music change timing based on a current play state of music being displayed through the audio module 110.

That is, although the sound adjusting part 117 determines the music to be played or the speed of the music through the above-described analysis, since the user may feel surprise or displeasure when the music or the speed of the music is instantly changed at a determined time, the music change timing needs to be adjusted.

Thus, the sound adjusting part 117 may recognize the current play state of the music being played through the audio module 110 and control the audio module 110 in a method of changing current music into next music after the current music is finished when the currently playing music has a remaining time equal to or less than a predetermined time.

Alternatively, the sound adjusting part 117 may change music when a volume is equal to or less than a predetermined level through volume information of the music being played. As the music may be changed at a time when an interlude or a lull of the music starts through the above-described method, the music or the speed of the music may be changed in a method of maximally reducing surprise or displeasure of the user.

According to an embodiment of the present invention, the sound adjusting part 117 may determine the music to be played through the audio module 110 and the speed of the music being played based on situational music preferences or situational music speed preferences of the user.

The sound adjusting part 117 may collect information of the situational music preferences or situational music speed preferences from the user, and this collecting process may be performed through the separate user terminal 200.

The sound adjusting part 117 may recognize the current state of the user through the biological signal information and the exercise state of the user through a combination of the biological signal information and the position information as described above. Thereafter, the sound adjusting part 117 may determine the music to be played through the audio module 110 and the speed of the music to be played by using the information of the situational music preferences or the situational music speed preferences collected from the user based on the current state and the exercise state of the user.

According to an embodiment of the present invention, the sound adjusting part 117 may have a function of adjusting a volume of the music to be played through the audio module 110 or a balance for each frequency band of the music to be played.

The sound adjusting part 117 may additionally adjust the volume of the music and the balance for each frequency band of the music based on the biological signal and the position signal information. Also, the user may implement a setting for a volume for each body condition or exercise condition and the balance for each frequency band in advance.

The control part 118 may function to controlling a data flow between the vibration part 111, the speaker part 112, the biological signal detecting part 113, the GPS module 114, the communication part 115, the storage part 116, and the sound adjusting part 117. That is, the control part 118 according to an embodiment of the present invention may control the vibration part 111, the speaker part 112, the biological signal detecting part 113, the GPS module 114, the communication part 115, the storage part 116, and the sound adjusting part 117 to perform own function thereof.

In FIG. 2, since at least a portion of each of the vibration part 111, the speaker part 112, the biological signal detecting part 113, the GPS module 114, the communication part 115, the storage part 116, and the sound adjusting part 117 is functionally classified from the control part 118, the above-described components may be integrated into one control part 118.

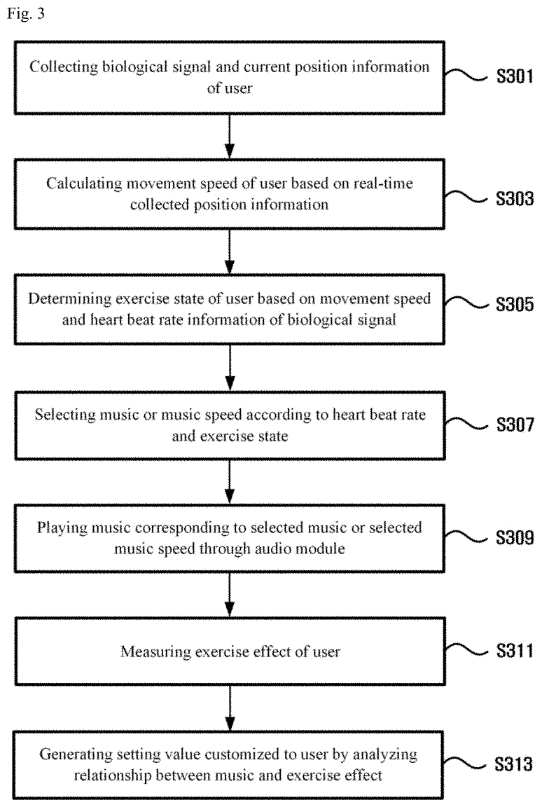

FIG. 3 is a flowchart representing a process of operating the wearable audio device 100 worn on a body of the user according to an embodiment of the present invention.

Referring to FIG. 3, the wearable audio device 100 may be worn on the body of the user to play and output music through the audio module 110 and simultaneously collect a biological signal and current position information of the user. The biological signal of the user may be collected by the biological signal detecting part 113 in the audio module 110, and the current position information of the user may be collected by the GPS module 114 in the audio module 110 in a process S301.

Thereafter, the wearable audio device 100 may calculate a movement speed of the user based on the position information of the user, which is real-time collected, in a process S303.

In an embodiment, the wearable audio device 100 may determine the exercise state of the user based on information corresponding to a heart beat rate of the collected biological signals and the movement speed information of the user, which is calculated in the process S303, in a process S305.

The wearable audio device 100 may select the music to be played in the audio module 110 and the speed of the music to be played based on the heart beat rate or the exercise state of the user in a process S307.

Thereafter, music corresponding to the music or the speed of the music selected in the process S307 may be played through the audio module 110 in a process S309, and the speed of the music being played through the audio module 110 may be changed when the speed of the music is selected. Also, a volume of the music, an output balance for each frequency band, etc. may be adjusted in conjunction with the speed of the music.

The wearable audio device 100 may real-time measure the exercise effect of the user in a process S311, and generate customized setting values for a specific user by analyzing a co-relationship between the music being played through the audio module 110 and the exercise effect. The customized setting values may be a play list or a selection method for each situation, or music speed information for each situation.

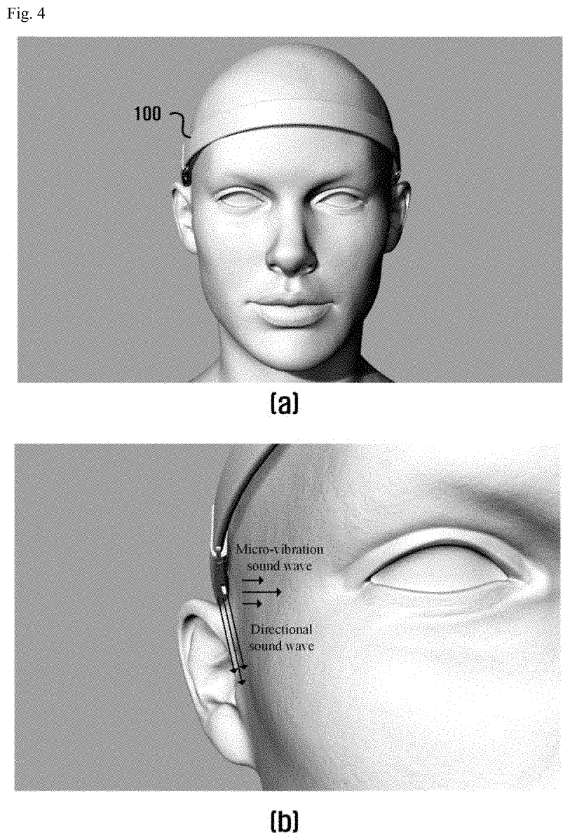

FIG. 4 is an exemplary view for explaining a wearing shape and an operation method of the wearable audio device 100 according to an embodiment of the present invention.

Referring to FIG. 4A, the wearable audio device 100 may be worn around a head circumference of the user like a hairband. In this case, the wearable audio device 100 may be worn in such a manner that the band-type fixing member 120 presses the head of the user, and two audio modules 110 contained in the wearable audio device 100 may be positioned corresponding to a left ear and a right ear of the user, respectively.

Referring to FIG. 4B, the vibration part 111 and the speaker part 112 in the wearable audio device 100 may generate a micro-vibration sound wave and a directional sound wave, respectively, and directions of the micro-vibration sound wave and the directional sound wave emitted from the audio module 110 may be differently set.

That is, the micro-vibration sound wave generated by the vibration part 111 may be transmitted in a direction toward the head of the user, and the directional sound wave generated by the speaker part 112 may be transmitted in a direction toward the ears of the user.

As described above, the audio module 110 in the wearable audio device 100 may have a structure that is designed such that the micro-vibration sound wave is transmitted in the direction toward the head of the user, and the directional sound wave is transmitted in the direction toward the ears of the user when worn on the body of the user.

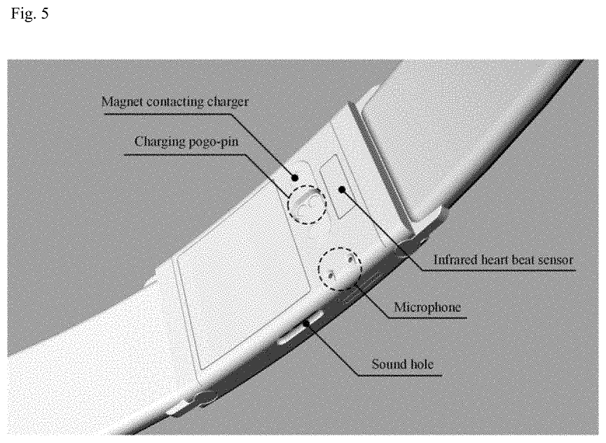

FIG. 5 is a view illustrating a portion of a detailed structure of the audio module 110 according to an embodiment of the present invention.

Referring to FIG. 5, the audio module 110 may include the biological signal detecting part 113, a microphone, and a sound hole, and further include a magnet and a pogo-pin, which are necessary for charging the audio module 110.

Although the biological signal detecting part 113 has an infrared heart beat sensor shape in FIG. 5, the biological signal detecting part 113 may detect various biological information such as a body temperature, an electrocardiogram, a humidity, and a skin pattern of the user.

The microphone may collect a sound generated from or around the body of the user, and the sound hole may serve as a passage of transmitting a sound generated by the audio module 110.

According to an embodiment of the present invention, the audio module 110 may be charged through a separate exclusive charger. The pogo-pin of the audio module 110 may contact a portion corresponding to the pogo-pin in the charger to perform the charging, and the magnet in FIG. 5 may contact the charger so that the charger and the audio module 110 further firmly contact each other.

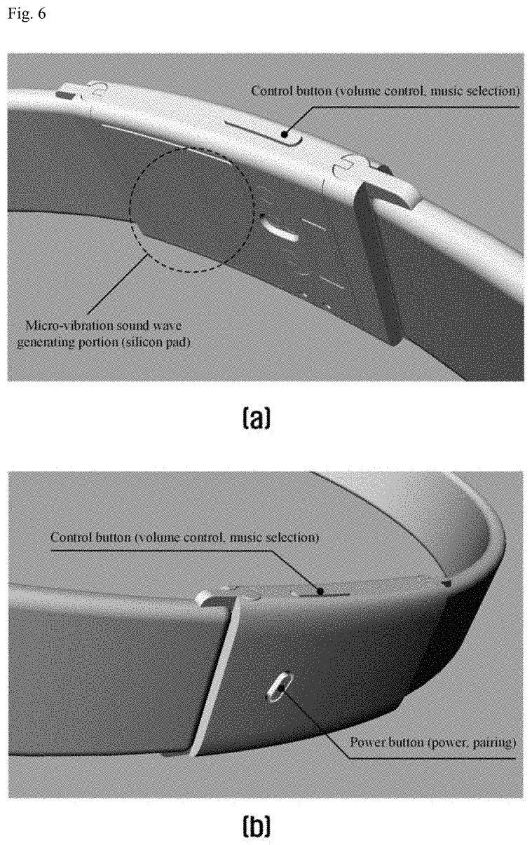

FIG. 6 is a view for explaining a portion that is controllable by the user and a vibration generating portion in the detailed structure of the audio module 110 according to an embodiment of the present invention.

Referring to FIG. 6A, a portion from which the micro-vibration sound wave generated by the vibration part 111 is discharged may be disposed in one area of the audio module 110, and a silicon pad may be contained in the portion to assist smooth transmission of the micro-vibration sound wave.

As a control button is disposed at a side surface of the audio module 110, the user may control the wearable audio device 100, e.g., volume control and music selection, by using the control button.

Referring to FIG. 6B, a power button capable of controlling a pairing between the audio module 110 and the user terminal 220 through power-on/off or Bluetooth may be disposed on an outer side surface of the audio module 100.

The control button and the power button of the audio module 110 may be disposed at a position, which is different from that in FIG. 6, on the audio module 110.

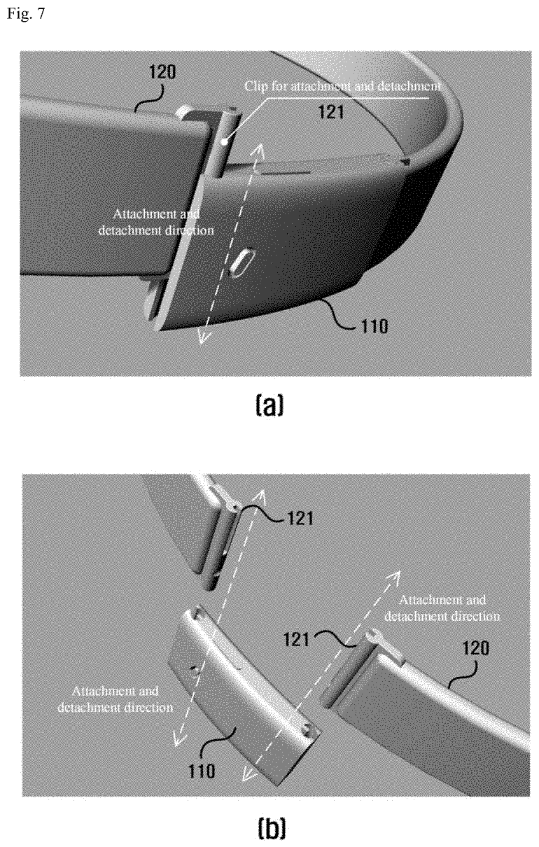

FIG. 7 is a view for explaining a method of attaching and detaching the audio module 110 and the fixing member 120 through the coupling part 121 according to an embodiment of the present invention.

Referring to FIG. 7, the audio module 110 and the fixing member 120 may be attached and detached through the coupling part 121 disposed on the fixing member 120. Specifically, the coupling part 121 may have a clip shape for attachment and detachment as illustrated in FIG. 7, and the attachment and detachment may be performed by inserting the coupling part 121 into a groove defined in the audio module 110.

FIG. 7A is a view illustrating a state in which the audio module 110 and the fixing member 120 are not completely attached to each other, and attachment or detachment is being progressed, FIG. 7B is a state in which the audio module 110 and the fixing member 120 are completely separated from each other.

However, the embodiment of the present invention is not limited to the shape of the coupling part 121 in FIG. 7. For example, the coupling part 121 may have various shapes so that the audio module 110 and the fixing member 1120 are coupled to each other. For example, clips for attachment and detachment may be provided on both side surfaces of the audio module 110 instead of the fixing member 120, and grooves corresponding thereto may be defined in the fixing member 120. Alternatively, the audio module 110 and the fixing member 120 may be coupled by using Velcro.

As described above, according to various embodiments of the present invention, the user of the wearable audio device may increase the exercise effect and extremely increase convenience of the user during exercising by using a device that automatically sets music and a music speed.

Also, the wearable audio device may generate user customized setting values by analyzing the situational exercise effect of the user wearing the wearable audio device and perform music selection and music speed adjustment based on the setting values.

The method and processes of algorithm described in relation to the embodiment of the present invention may be directly realized as a hardware, a software module executed by the hardware, or a combination thereof. The software module may be stored in a random access memory (RAM), a read only memory (ROM), an erasable programmable ROM (EPROM), an electrically erasable programmable ROM (EEPROM), a flash memory, a hard disk, a removable disk, a CD-ROM, or computer readable recording media well-known in the technical field to which the present invention belongs.

The description of the present invention is intended to be illustrative, and those with ordinary skill in the technical field of the present invention will be understood that the present invention can be carried out in other specific forms without changing the technical idea or essential features. Thus, the above-disclosed embodiments are to be considered illustrative and not restrictive.

What is claimed is:

1. A wearable audio device comprising:
at least one audio module configured to output a sound; and
a fixing member having a band shape and comprising at least one coupling part to which the audio module is inserted or attached,
wherein the audio module comprises:
a biological signal detecting part configured to collect a biological signal from a body of a user;
a GPS module configured to generate position information of the audio module; and
a sound adjusting part configured to determine music to be played through the audio module or a speed of music based on the biological signal collected from the biological signal detecting part or the position information collected from the GPS module.

2. The wearable audio device of claim 1, wherein two audio modules are provided, and
one of the audio modules is inserted or attached to a first coupling part of the fixing member, and the other of the audio modules is inserted or attached to a second coupling part spaced apart from the first coupling part in the fixing member having a band shape.

3. The wearable audio device of claim 1, wherein when music to be played through the audio module or a speed of music is determined based on the biological signal collected from the biological signal detecting part or the position information collected from the GPS module,
the sound adjusting part determines the music to be played or the speed of the music by receiving, from a user terminal, information of the music or the speed of the music that is determined by the user terminal configured to receive the biological signal collected from the biological signal detecting part or the position information collected from the GPS module from the wearable audio device.

4. The wearable audio device of claim 1, wherein the biological signal is a heart beat rate of the user, and
the sound adjusting part controls the music determined based on a user exercise state that is determined based on the heart beat rate of the user and the position information generated through the GPS module to be played by the audio module.

5. The wearable audio device of claim 1, wherein the biological signal is a heart beat rate of the user, and, and
the sound adjusting part adjusts the speed of the music being played by the audio module based on a user exercise state that is determined based on a heart beat rate of the user and the position information generated through the GPS module.

6. The wearable audio device of claim 1, wherein the sound adjusting part measures an exercise effect according to the music played in the audio module and the speed of the music based on the biological signal collected from the biological signal detecting part, and generates a setting value specified for a specific user based on the measured exercise effect.

7. The wearable audio device of claim 1, wherein the sound adjusting part determines a timing for changing music based on a current play state of music being played through the audio module after the music to be played through the audio module is determined.

8. The wearable audio device of claim 1, wherein the sound adjusting part determines the music to be played or the speed of the music to be played based on situational music preferences or situational music speed preferences of the user.

9. The wearable audio device of claim 1, wherein the sound adjusting part additionally adjusts a volume of the music to be played or a balance for each frequency band of the music to be played in addition to the music to be played through the audio module or the speed of the music to be played.

10. A method for controlling an audio module by a wearable audio device comprising at least one audio module, comprising:
collecting a biological signal from a body of a user through a biological signal detecting part contained in the audio module;
collecting position information of the audio module through a GPS module contained in the audio module; and
determining music to be played through the audio module or a speed of music to be played based on a biological signal collected from the biological signal detecting part or position information collected from the GPS module.
